(19) United States
(12) Patent Application Publication
(10) Pub. No.: US 2016/0325993 A1
(43) Pub. Date: Nov. 10, 2016

(54) OXYGEN TRANSPORT MEMBRANE

(71) Applicant: DENMARKS TEKNISKE UNIVERSITET, Lyngby (DK)

(72) Inventors: Martin Søgaard, Ringe (DK); Jonas Gurauskis, Copenhagen (DK); Dhavanesan Kothanda Ramachandran, Tami Nadu (IN); Alfred Junio Samson, San Agustin Village (PH); Shiyang Cheng, Roskilde (PH); Andreas Kaiser, Roskilde (DK); Peter Vang Hendriksen, Hillerød (DK)

(21) Appl. No.: 15/110,602

(22) PCT Filed: Jan. 23, 2015
(86) PCT No.: PCT/EP2015/051392

§ 371 Date: Jul. 8, 2016

(30) Foreign Application Priority Data
Jan. 24, 2014 (EP) 14152372.0

(51) Int. Cl. C01B 13/02; B01D 65/10; B01D 69/10; B01D 53/22; B01D 71/02

(52) U.S. Cl. CPC C01B 13/0288; B01D 53/225; B01D 71/024; B01D 69/10; B01D 65/10; B01D 2325/10; B01D 2325/26; C01B 2210/0012; C01B 2210/0003

(57) ABSTRACT

The present invention relates to a novel composite oxygen transport membrane as well as its preparation and uses thereof.

### FIELD OF INVENTION

The present invention relates to a novel composite oxygen transport membrane as well as its preparation and uses thereof.

### BACKGROUND OF INVENTION

Oxygen transport membranes are used to separate oxygen from an oxygen containing gas, such as for example air. The membranes are made of a material that is capable of conducting oxygen ions and electrons through the membrane at elevated temperatures, such as above 550° C. The membrane can be made of a single phase material, which is capable of conducting both oxygen ions and electrons (a so called mixed ionic and electronic conductor (MIEC), or the membrane can be made of a mixture of materials that includes both an ionic conductor and an electron conductor, where the ionic conductor is primarily capable of conducting ions and the electronic conductor is primarily capable of conducting electrons.

When a partial pressure difference of oxygen is applied on opposite sides of the membrane, oxygen atoms, or more precisely oxygen molecules, will ionize (i.e. form oxide ions (O²⁻)) on one surface of the membrane and emerge on the opposite side of the membrane, where the oxide ions will re-convert into oxygen atoms, or more precisely oxygen molecules. The free electrons resulting from the re-conversion will be transported back through the membrane to ionize further oxygen atoms in the oxygen containing feed gas. The oxygen partial pressure difference can be produced by providing the oxygen containing feed gas to the membrane at either at ambient or elevated pressure and/or by supplying a combustible substance to the permeate gas, which is opposite to the oxygen containing gas.

Typically, oxygen transport membranes are composite structures that include a dense membrane layer composed of the ionic and electronic conducting material, and one or more porous supporting layers. Since the resistance to oxygen ion transport in the membrane layer is proportional to the thickness of the membrane, the dense layer is made as thin as possible, and therefore most often it must be supported. In such cases, a porous support layer is located at one or at both sides of the dense membrane layer. Typically, the porous support layers are infiltrated with a catalyst material to facilitate the chemical reaction taking place at each side of the membrane.

A well-known problem with such supported membranes is connected with the fact that the oxygen separation process occurs at high temperatures, such as above 550° C. Therefore, in cases where the dense membrane layer and the supported layers are made of different materials, differences in thermal expansion coefficients of the different materials can lead to degradation of the membrane structure.

Another problem with composite membranes is that particles of different materials must form a continuous network of electronic and oxygen conducting pathways, which often requires a high content of the electron conducting materials, which limits the oxygen permeation rate.

Cerium gadolinium oxide (CGO) also known as gadolinium-doped ceria (GDC) is a ceramic electrolyte, which may be used for example in solid oxide fuel cells. It is one of a class of ceria-doped electrolytes with higher ionic conductivity than those of yttria-stabilised zirconia (YSZ), which is one of the most commonly used oxide ion conductors and electrolyte in solid oxide fuel cells. Using CGO in membrane applications is thus advantageous due to the superior oxide ion conductivity of the material compared to most other oxide materials. Also under very reducing conditions CGO shows a significant electronic conductivity which can be beneficial for the application as a membrane material. The electronic conductivity of CGO is furthermore increased at high temperatures, such as at the operation conditions of a membrane.

The present invention relates to an oxygen transport membrane that is suitable for oxygen production or integration into processes where oxygen is needed. The membrane is based on two porous back bone layers that can be infiltrated with catalyst materials and between these, a dense membrane layer made from a composite material. Optionally, a cheap, inert porous support may also be included into the composite membrane. The dense membrane layer is in this case closely matched in thermal expansion coefficient (TEC) to that of the support material so that degradation of the membrane structure due to differences in thermal expansion coefficients is minimized or avoided. A further advantage of the membrane according to the present invention is that it is possible to obtain very high oxygen fluxes at low temperatures.

A further advantage of the present invention is the very high oxygen fluxes obtained with a membrane where all three layers comprise CGO. Very high oxygen fluxes are also known for other membrane materials, such as membranes comprising BSCFZ (Ba_{0.5}Sr_{0.5}Co_{0.8}Fe_{0.2}O_{2-δ}) and variants thereof. However, the BSCFZ material suffers from drawbacks such as toxicity, higher costs, it is not compatible with CO₂ as feed gas, and the known BSCFZ membrane production difficult to upscale.

Another advantage of the present invention is the minimal use of catalyst material. In an embodiment of the invention, catalyst is added by infiltration to the porous layer of the membrane which is not supported by an inert support. Thus, the amount of catalyst used and the steps of infiltration is minimised, thereby decreasing material and fabrication costs.

### SUMMARY OF INVENTION

In a first aspect the present invention relates to a composite oxygen transport membrane comprising at least three layers. These three layers are:
a first porous layer,
a dense membrane layer positioned on top of the first porous layer, and
a second porous layer positioned on top of the dense membrane layer,
   wherein the first and the second porous layer comprises a CGO (cerium gadolinium oxide), and the dense membrane layer comprises at least one ionic conducting material and at least one electronic conducting material, where said at least one ionic conducting material is a CGO (cerium gadolinium oxide), and wherein the first and/or the second porous layer is further supported by an inert porous support material, where the porous support material comprises magnesium (Mg).

The second aspect of the present invention relates to a process for preparing the composite oxygen transport membrane by depositing the structural layers on top of each other and optionally infiltrating the first and/or the second porous layer with a catalyst material.

In a further aspect, the present invention relates to a process for preparing the composite oxygen transport membrane by providing an inert porous support layer and depositing the structural layers on top of each other and infiltrating the second and optionally the first porous layer with a catalyst material, where the first porous layer is supported by the inert porous support material.

The third aspect of the present invention relates to the different uses of the composite oxygen transport membrane of the present invention.

### DESCRIPTION OF DRAWINGS

FIG. 1 shows a pre-sintering cycle of structural MgO support with tubular geometry.

FIG. 2 shows a pre-sintering (a) and final sintering (b) cycles employed to reach the final membrane microstructure.

FIG. 3 depicts scanning microscopy images of a) larger part of the manufactured membrane b) zoom in on the membrane.

FIG. 4 depicts a schematic sketch of equipment used to measure the oxygen permeation flux of the composite membrane tested in Example 2.

FIG. 5 depicts the oxygen flux as a function of the outlet oxygen partial pressure for the composite membrane tested in Example 2.

FIG. 6 shows sketches of embodiments of the present invention, where (a) shows an embodiment where the first and second porous layers are not infiltrated with a catalyst, (b) shows an embodiment where the first porous layer, which is supported by an inert support layer, is not infiltrated, and the second porous layer is infiltrated with a catalyst, and (c) shows an embodiment where both the first and second porous layers are infiltrated with a catalyst.

FIG. 7 shows the oxygen flux as a function of the outlet oxygen partial pressure for a membrane of the type sketched in FIG. 6b, where the first porous layer supported by an inert support layer is not infiltrated, and the second porous layer is infiltrated with a catalyst. (a) shows the oxygen flux, when N₂ is used as sweep gas, (b) shows the oxygen flux, when oxygen containing CO₂ is used as sweep gas, and (c) shows the oxygen flux when using hydrogen as sweep gas and air as feed gas. The oxygen flux is plotted as function of the hydrogen sweep flow and for different temperatures.

FIG. 8 shows the oxygen flux as a function of time for a membrane of the type sketched in FIG. 6b, where the first porous layer supported by an inert support layer is not infiltrated, and the second porous layer is infiltrated with a catalyst. (a) shows the flux at 850° C. in a CO₂ containing feed gas, and (b) shows the flux at 700° C. in a H₂ containing feed gas.

### DETAILED DESCRIPTION OF THE INVENTION

The present invention relates to a composite oxygen transport membrane comprising at least three layers. These three layers are:
a first porous layer,
a dense membrane layer positioned on top of the first porous layer, and
a second porous layer positioned on top of the dense membrane layer.
   The first and the second porous layer comprises a CGO (cerium gadolinium oxide), and the dense membrane layer comprises at least one ionic conducting material and at least one electronic conducting material, where said at least one ionic conducting material is a CGO (cerium gadolinium oxide), and wherein the first and/or the second porous layer is further supported by an inert porous support material, where the porous support material comprises magnesium (Mg).

The present invention also relates to a composite oxygen transport membrane comprising at least three layers. These three layers are:
a first porous layer,
a dense membrane layer positioned on top of the first porous layer, and
a second porous layer positioned on top of the dense membrane layer.
   The first and the second porous layer comprises CGO (cerium gadolinium oxide), and preferably the first and/or the second porous layer comprises at least 25 vol % CGO. In one embodiment the first and/or the second porous layer comprises at least 99.9 vol % CGO. In one embodiment the first and/or the second porous layer consists of CGO and a catalyst material.

By the term “CGO” as used herein is meant cerium gadolinium oxide, which is also known as gadolinium-doped ceria (GDC). Moreover, as used herein CGO refers to any compound, which can be described by the chemical formula Ce₁₋ₓGdₓO_{y}, where 0≦x≦0.4. CGO may act both as an ionic conducting material or a single phase mixed ionic and electronic conducting (MIEC) material under reducing conditions. The mixed ionic and electronic conductivity of CGO is known to increase with temperature.

The dense membrane layer comprises at least one ionic conducting material and at least one electronic conducting material, where said at least one ionic conducting material is CGO. By the term “comprising at least one ionic conducting material and at least one electronic conducting material” as used herein is meant that the dense membrane layer can be made of a single phase (MIEC) material, which is capable of conducting both oxygen ions and electrons, or the dense membrane layer can be made of a mixture of materials that include both an ionic conducting material and an electron conducting material. In one embodiment the dense membrane layer consist of CGO, where the CGO will have mixed ionic and electronic conductivity, and preferably the CGO will have a significant part of electronic conductivity.

In most cases the first and/or the second porous layer of the membrane must be supported by an inert porous support material, because the thickness of the oxygen transport membrane is typically very thin. This is because the resistance to oxygen ion transport depends on the thickness of the membrane and therefore a very thin membrane is typically aimed at. In such cases a porous support layer is located at one or at both sides of the dense membrane layer. In principle any kind of inert porous support material can be used, however, MgO is the preferred material due to its excellent inertness and low cost. Other examples of suitable porous support materials include (Y, Mg, Al)-doped ZrO₂. Advantageously, the inert porous support material comprises magnesium (Mg). More preferably, the support material comprises Mg, and is a material or a composite, with a thermal expansion coefficient (TEC) that is similar to the TEC of the dense membrane layer.

To minimize the mechanical stresses between the layers of the membrane, it is advantageous that the layers have similar mechanical properties, such as similar thermal expansion coefficient (TEC), which may be obtained by the layers comprising similar materials. In a further embodiment of the invention, the first porous layer and/or the second porous layer comprises at least 25 vol % of a CGO. In another embodiment the first and/or second porous layer comprises above 95 vol % of a CGO, and in a further embodiment at least 99.9 vol % of a CGO.

The dense membrane layer always comprises at least one ionic conducting material and at least one electronic conducting material. The at least one ionic conducting material is CGO, however, in some embodiments other ionic conducting material may also be present in the dense membrane layer. Examples of such other ionic conducting materials include (Pr,Tb,Sm,Nd)-doped CGO, and Sc-doped YSZ (yttria stabilised zirconia). In one embodiment the membrane layer comprises any combination of (Pr, Gd)-doped ceria. In one embodiment the membrane layer consists of any combination of (Pr, Gd)-doped ceria. The at least one electronic conducting material may in principle be any kind of electronic conducting material, such as for example Sc, Ti, V, Cr, Mn, Co, Ni, Cu, Zn, Y and Zr-doped LSF. However, the preferred electronic conducting material is LSF (lathanum strontium ferrite).

To further minimize the mechanical stresses between the layers of the membrane, the layers of the membrane may comprise similar materials. In an embodiment of the invention, the CGO of the first porous layer, the CGO of the dense membrane, and the CGO of the second porous layer, is a CGO of the same chemical formula.

In a further embodiment of the present invention CGO in the membrane layer is substituted by either of Pr-doped ceria, Tb-doped ceria, Sm-doped-ceria, Nd-doped ceria, and any combinations thereof. In a particular embodiment CGO in the membrane layer is substituted by Pr-doped ceria. An embodiment is therefore, a membrane, wherein the CGO of the dense membrane layer is substituted by one or more cerias selected from the group of Pr-doped ceria, Tb-doped ceria, Sm-doped ceria, and Nd-doped ceria.

In one preferred embodiment the dense membrane layer is made of Ce_{0.9}Gd_{0.1}O_{1.95} as the ionic conducting material and (La_{0.6}Sr_{0.4})_{0.98}FeO₃ as the electronic conducting material. In some embodiments the volume ratio of the ionic and electronic conducting material is 1-100 vol % of Ce_{0.9}Gd_{0.1}O_{1.95} and 0-99 vol % of (La_{0.6}Sr_{0.4})_{0.98}Fe₀₃. In other embodiments the volume ratio of the ionic and electronic conducting material is 50-100 vol % of Ce_{0.9}Gd_{0.1}O_{1.95} and 0-50 vol % of (La_{0.6}Sr_{0.4})_{0.98}Fe_{0.3}. In a particular preferred embodiment the volume ratio of the ionic and electronic conducting material is 65-75 vol % of Ce_{0.9}Gd_{0.1}O_{1.95} and 25-35 vol % of (La_{0.6}Sr_{0.4})_{0.98}FeO₃. In the most preferred embodiment the volume ratio of the ionic and electronic conducting material is 70 vol % of Ce_{0.9}Gd_{0.1}O_{1.95} and 30 vol % of (La_{0.6}Sr_{0.4})_{0.98}FeO₃.

It is considered beneficial if the membrane during the manufacturing is under no stress or a compressive stress, meaning that the integral thermal expansion coefficient of the support structure must be larger than that of the membrane. Specifically, the integral thermal expansion coefficient of the dense membrane should be within the range of −5×10⁻⁶ K⁻¹ to +1×10⁻⁶ K⁻¹ of that of the support structure in the temperature range up to the sintering temperature of the component. More specifically, the integral thermal expansion coefficient of the dense membrane should be within the range of 5×10⁻⁶ K⁻¹ to −1×10⁻⁶ K⁻¹ of that of the support structure in the temperature range up to the sintering temperature of the component, In an preferred embodiment, the integral thermal expansion coefficient of the dense membrane should be lower than that of the support. An embodiment of the invention is a composite oxygen transport membrane comprising at least three layers, said layers being a first porous layer, a dense membrane layer positioned on top of the first porous layer, and a second porous layer positioned on top of the dense membrane layer, wherein the first and the second porous layer comprises a CGO (cerium gadolinium oxide), and the dense membrane layer comprises at least one ionic conducting material and at least one electronic conducting material, where said at least one ionic conducting material is a CGO (cerium gadolinium oxide), and wherein the first and/or the second porous layer is further supported by an inert porous support material, where the difference in thermal expansion coefficient (TEC) between the support material and the dense membrane (TEC(support)—TEC(membrane)) is between ca. 5×10⁻⁶ K⁻¹ and −1×10⁻⁶ K⁻¹. The TEC values here referred to, are integral TEC measurements from room temperature to the maximum temperature that is used in the manufacturing of the membrane

The oxygen transport membrane may be used in many different applications and the chemical reactions taking place at each side of the membrane will differ from application to application. In most cases such chemical reactions proceed more effective if they are catalysed. A catalyst material may therefore typically be present in both the first and the second porous layer. For many applications, it is known that the presence of catalysts is essential for obtaining high performance, such as high oxygen fluxes for a membrane. Suitable examples of catalyst materials include strontium-doped LaCoO₃, iron-doped LaCoO₃ and Pr. In one embodiment both the first and the second porous layer comprises strontium-doped LaCoO₃ as the catalyst. In another preferred embodiment the first porous layer comprises strontium-doped LaCoO₃ as the catalyst and the second porous layer comprises Ni or Ru or Cu, or any combination thereof as the catalyst. In an preferred embodiment, the first porous layer is supported by the inert porous support material. In another preferred embodiment, the second porous layer is supported by the inert porous support material. In a further embodiment of the invention, the first porosu layer which is supported by the inert porous support material does not comprise a catalyst, and the second porous layer comprises strontium-doped LaCoO₃ as the catalyst.

To minimise the use of catalyst material and fabrication steps, it may be advantageous to only have catalyst present in one of the porous layers. In an embodiment of the invention, a catalyst material is present in the first and/or the second porous layer. Despite the common knowledge that catalyst is needed to obtain high oxygen fluxes, the present invention surprisingly shows that high oxygen fluxes can be obtained using reduced amounts of catalyst, such as reduced amounts of catalyst on one side of the membrane.

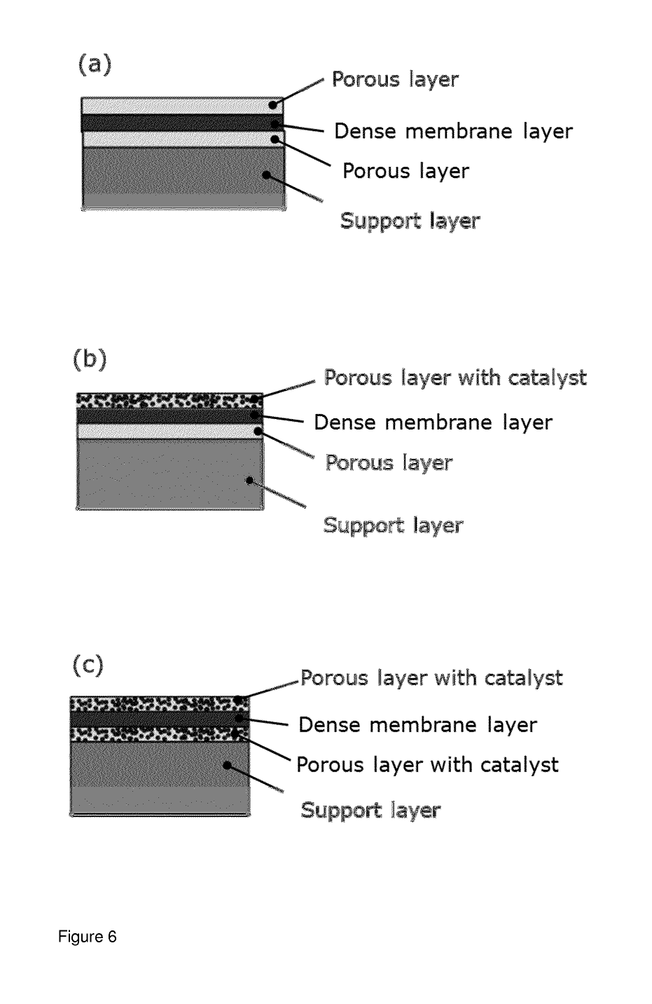

To minimise the use of catalyst material, where only one of the porous layers comprises catalyst, it is advantageous that the porous layer which is not supported by the inert porous support, comprises the catalyst. Thus, catalyst material deposited within the inert support structure may be avoided during the fabrication of the membrane. In an embodiment of the invention, the layer that is not supported by an inert porous support, comprises a catalyst. FIG. 6 illustrates three embodiments of the invention, where (a) none of the porous layers comprise catalyst, (b) the porous layer which is not supported by the support comprises catalyst, and (c) both porous layers, and optionally the porous support, comprise catalyst.

Nano-sized catalyst are known to be advantageous for the chemical reactions. In an embodiment of the invention, the size of the catalyst within the first and/or second porous layer is below 500 nm, more preferably below 200 nm, and most preferably below 100 nm.

The oxygen transport membrane according to the present invention may be manufactured according to the general procedure described below. One particular way to manufacture the oxygen transport membrane according to the invention is disclosed in details in the Examples.

In general terms the manufacturing process can be divided into the following steps:
1. support layer manufacturing,
2. deposition of functional layers (i.e. the first and second porous layers and the dense membrane layer) on the support layer, and
3. optional infiltration of the first and/or second porous layers.

In an embodiment of the invention, the manufacturing process can be divided into the following steps:
1. support layer manufacturing,
2. deposition of functional layers on the support layer (i.e. the first porous layer, the dense membrane layer, and the second porous layer), and
3. infiltration of the second and optionally the first porous layers with a catalyst or catalyst precursor.

In a further embodiment of the invention, the method comprises an inert porous support layer comprising magnesium (Mg), more preferably comprising MgO, and most preferably is MgO.

The third infiltration step, where a catalyst material is supplied to the first and/or second porous layers, is optional and only necessary in cases where the membrane is used in processes where the chemical reaction on the feed and/or the permeate side requires the presence of a catalyst in order to proceed in a feasible way. Alternatively, the catalyst material is included in the first and second porous layer at an earlier stage and before deposition of said layers in step 2.

In the first step the support layer is manufactured. This first step could be performed by use of any such known manufacturing method. The preferred method, however, is based on a thermoplastic route, which has some advantageous above the water based extrusion. These advantageous are among others (i) it gives the possibility of recycling/re-using defective components after shaping but prior to sintering, (ii) the unwanted abrasion of engineering parts of processing equipment (i.e. extruder; the chamber and die head parts) is reduced at high polymer contents, and (iii) thin-walled self-supporting structures with close dimensional tolerances can be achieved. On the other hand the thermoplastic route is significantly more expensive than the water based route. The thermoplastic route comprises the steps of i) powder pre-treatment, ii) kneading, and iii) extrusion.

In the second step the functional layers are deposited one by one on top of each other. First the first porous layer is deposited on top of the support layer. Next the dense membrane layer is deposited on top of the supported first porous layer. Finally the second porous layer is deposited on top of the dense membrane layer. This deposition of functional solid oxide layers on a structural support layer could be performed by any method well-known in the art, but preferably the deposition is performed via a colloidal processing route based on a dip coating technique. This requires a number of colloidal suspensions with the desired solid oxide compositions and their sequential deposition on the structural support. In all these colloidal suspensions ethanol is preferably used as a solvent media. By using an organic based solvent system faster drying rates of the deposited layers is achieved. Nevertheless, water based suspensions are possible for the same purpose and would be beneficial for large scale production. The process to obtain the membrane with the geometry in question is typically based on the following steps: i) pre-sintering of the support, ii) deposition of the first porous layer, iii) deposition of the dense membrane layer, and iv) deposition of the second porous layer.

In the third optional infiltration step the first and/or the second layer is infiltrated with a suitable catalyst. These catalysts can be transferred to these layers in different ways. In one approach the porous layer is brought into contact with a solution containing metal ions. Due to the capillary forces the solution is sucked into the porous layers and also through the porous support. After a suitable heat treatment catalyst particles are formed. The procedure of bringing the porous layer in contact with a solution may be repeated a number of times in order to ensure that sufficient catalyst material become present in the layers. A second approach for obtaining catalyst particles in the porous layer relates to preparing a slurry containing nano-particles of the desired catalyst and bringing this slurry in contact with the porous layer. The slurry and catalyst particles will again be incorporated into the porous layers via the capillary force.

Such infiltration processes are known for the skilled person and the process is disclosed for example in A. Samson, M. Sogaard, R. Knibbe, N. Bonanos, High performance cathodes for solid oxide fuel cells prepared by infiltration of La0.6Sr0.4Co0.3-δ into Gd-doped ceria, Journal of the Electrochemical Society 158 (2011) B650-B659.

The membrane according to the present invention may be used in different applications such as:
Syngas production, where natural gas is converted to CO and H₂ and typically further converted to liquid or other value added products,
Oxygen production, where the membrane can be used for pure (small scale) oxygen production at a stand alone facility. Oxygen production with membranes is particularly associated with a small energy penalty if the membranes can be integrated with a high temperature process,
Oxygen enrichment of air, where oxygen is added to air in order to burn things at a higher temperature, which is required in a number of industries such as for example the cement industry,
Chemical production, where the membranes can be used for a number of chemical reactions including oxidative coupling of methane or production of hydrogen cyanide, and
Oxygen production for biomass gasification, where the biomass is converted into carbon monoxide, hydrogen and carbon dioxide, which is achieved by reacting the biomass at high temperatures (700° C.) with a controlled amount of oxygen and/or steam, and
Oxygen production for glycerol decomposition, such as direct glycerol oxidation.

### EXAMPLES

### Example 1

### Preparation of the Oxygen Transport Membrane

The manufacturing process can be divided into the following steps:

1. Manufacture of MgO support layer

2. Deposition of functional layers on structural MgO support with tubular geometry

3. Infiltration of inner and outer porous layers

1. Manufacture of MgO Support Layer:

The procedure for manufacturing the support layer of magnesium oxide (MgO) goes through the following steps: i) powder pre-treatment, ii) kneading, iii) extrusion.

i) Powder Pre-Treatment:

Two types of powders were used for the preparation the support; (1) MgO powder (Product # 12R-0801, Inframat Advanced Materials, USA), and (2) a graphite powder (TIMREX® KS6, TIMCAL, Switzerland). The uncalcined MgO powder had a very large surface area of 78 m²/g (BET) and consisted of extremely fine (nanometric) primary particles that could not be fully de-agglomerated by kneading or pre-dispersion in stearic acid. For better dispersion (easier de-agglomeration), the raw ceramic powders (MgO) was pre-calcined at 1000° C. with a heating rate of 100° C./h for 10 h to reduce the surface area of the powder from 78 m²/g to 10.8 m²/g. Further de-agglomeration of the pre-calcined MgO powder could then be achieved by milling and pre-coating with stearic acid. 37 ml stearic acid was dissolved in 1500 ml of 1-proponal and ball milled for 2 h to completely mix. To this mixture approximately 585 g of MgO was added. The solvent was removed from the MgO slurry by drying on a hot plate for 24 h at 90° C. This stearic acid coating helped to reduce the tendency of the fine MgO raw powder to adsorb water and agglomerate, and further improved powder handling (e.g. significantly reduced dust formation during the kneading process).

ii) Kneading

After the powder pre-treatment process, the feedstock for extrusion was prepared using kneading from the pre-treated MgO powder, graphite, a thermoplastic binder (Elvax 250, Du Pont; USA), paraffin wax (Sigma-Aldrich, USA) as a plasticizer. The volume percentages of each of the components are listed in Table 1 (stearic acid was added in the powder pre-treatment). The feedstock has been optimized with respect to the form stability after extrusion, shrinkage behavior during extrusion and the sintering process.

TABLE 1
Content of final extrusion mass.

| | MgO | Polymer & additives | Graphite |
|---|---|---|---|
| Code | (vol. %) | (vol. %) | (vol. %) |
| MgO-017 | 34 | 46 | 20 |
| | | (Stearic acid 9%, | |
| | | Elvax 26% and Parafin 11%) | |

All three types of ingredients were weighted and mixed in the kneader (Linden, Type BK20-Vol 500 cc, Germany) in the following sequences in order to achieve homogeneous mixing. First, the kneader was heated to the operating temperature, filled with half of the MgO powder and allowed to run at a low speed of 10 rpm in order to transfer heat to the MgO powder and mill any larger aggregates. Next, the polymers (Elvax 250 and paraffin wax) and the remaining MgO powder were added consecutively. After a homogeneous mixture was achieved, the graphite powder was added, and mixed further until a uniform mixture was achieved. After filling, the feedstock was kneaded for 30 min at 30 rpm in order to get a better homogeneous mixture.

iii) Extrusion

After the kneading process, the feedstocks were ground into small pieces by running the kneader at room temperature. Then the kneaded feedstocks were used to shape into tubular shapes using a die assembly of Ø=14 mm outer diameter and Ø=12 mm inner diameter by using an extruder (Model 19/20DN Brabender, Germany). An oil bath was used to achieve a desired temperature of 100° C. and 90° C. for the extruder chamber and die head, respectively. The die head temperature is always kept 10° C. lower than the chamber temperature in order to ensure form stability of the extruded tube that exits the die. An extruder speed of 10 RPM was used throughout the extrusion experiments.

2. Deposition of Functional Layers on Structural MgO Support with Tubular Geometry

Deposition of functional solid oxide layers on a structural MgO support with tubular geometry is performed via a colloidal processing route based on the dip coating technique. This requires a number of stable colloidal suspensions with the desired solid oxide compositions and their sequential deposition on the structural support. The process to obtain the membrane with the geometry in question is based on the following steps: i) pre-sintering of the MgO support, ii) deposition of the inner porous CGO layer, iii) deposition of the dense CGO/LSF composite membrane layer, and iv) deposition of the outer porous CGO layer.

Deposition is carried out using an immersion and extraction (dip coating) speed of 3 mm/s with a hold time of 10 seconds. A detailed description of each dip-coating step with the corresponding thermal treatment cycles is given below.

i) Pre-Sintering of the WO Support

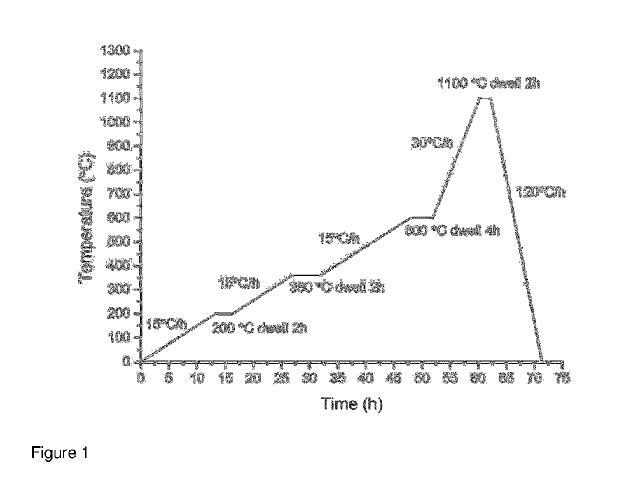

The MgO support pre-sintering step is based on the removal of organic media used during the thermoplastic extrusion process. The high load of organic media (Elvax, graphite, stearic acid, paraffin wax) within the green state MgO tubes requires a relatively slow thermal treatment cycle in order for the support structure not to crack (FIG. 1). Furthermore, high volume of gases formed during this organic removal cycle can be detrimental to the integrity of the functional layers. Therefore, the MgO supports are thermally treated to eliminate all organic media and pre-sintered to reach some structural strength to be safely manipulated in consequent manufacturing steps. As seen from FIG. 1, the calcination cycle maximum temperature is set to be 1100° C. to reach some initial pre-sintering of the MgO structure. It is crucial that the component is not sintered at a too high temperature as it is a requirement that some sintering shrinkage is still available for the subsequent deposition, sintering and densification of the dense membrane layer. As part of the MgO support-conditioning step, the deposition of the inner porous CGO layer (described in the following) can be done prior to the initial sintering. For the component here described, the inner support layer was deposited prior to the calcination of the MgO support. The high structure porosity of this layer showed to stay intact during the organics removal step from the MgO support.

ii) Deposition of the Inner Porous CGO Layer

Deposition of the inner porous CGO layer can be done both on the green state and on the pre-sintered MgO tubular support. As mentioned above, in this example the inner porous layer of CGO is deposited on a green state (i.e. a non-(pre)-sintered) tube). The dip coating is performed using stable colloidal suspensions with the solid oxide Ce_{0.9}Gd_{0.1}O_{1.95}-δ (CGO). The composition and preparation details of the suspension are given in Table 2.

TABLE 2
Composition of porous CGO layer suspensions.

| | | | | |
|---|---|---|---|---|
| Inner | Solid | CGO uhsa (uhsa = Ultra | 4-5 vol. % | Milling 24 |
| porous | phase | High Surface Area) pre- | solid load | hours in |
| CGO | | calcined at 1100° C. | | ball mill |
| layer | Solvent | Ethanol | | |
| | Surfactant | PVP K10 | 6 wt. % of | |
| | | | initial solid | |
| | | | load | |
| | Binder | Ethyl cellulose | 10 wt. % of | |
| | | | initial solid | |
| | | | load | |
| Outer | Pore | Graphite | 20 wt. % of | Slow roll |
| porous | former | | initial solid | min. 24 |
| CGO | | | load | hours. |
| layer | Binder | PVP K90 | 5 wt. % of | |
| | | | total solid | |
| | | | load | |

To retain high porosity of this layer, the suspensions is prepared with CGO powder which was previously thermally treated at 1100° C. (dwell 2 h) and 20-40 vol.% of solid load of sacrificial pore former in form of graphite flakes. Both, CGO powder and graphite flakes, are stabilized using polymeric surfactant which work both on hydrophilic and hydrophobic surfaces. Binders are added to the suspension to achieve a good adhesion to the MgO support and a high strength of porous CGO layer in the green state. The solid loading of the suspension is varied to reach the final sintered thickness of approx. 20-30 microns. The solid loading is set to be 4 vol.% when the deposition is performed on pre-sintered MgO supports and 5 vol.% when the deposition is done on the green state MgO support.

The adjustments in suspensions solid loading are needed to compensate for the increase in the layer thickness due to the capillary forces when the deposition is performed on pre-sintered MgO supports. The suspensions (in both deposition cases) should demonstrate pseudoplastic behaviour with viscosity values at low shear range (<1 s⁻¹) being close to 200 mPa·s and at high shear range (>10 s⁻¹) close to 60 mPa·s.

iii) Deposition of the Dense CGO/LSF Composite Membrane

The CGO and (La_{0.6}Sr_{0.4})_{0.98}FeO_{3-δ}(LSF) phases are stabilized using an optimized quantity of polymeric dispersant in ethanol media. Low binder content (5 wt.% of solid loading) is used to achieve a handling level of structural strength in the green state and a low residual porosity. Table 3 lists the contents of the dip coating slurries

TABLE 3
Composition of dense CGO/LSF layer suspension.

| | | | | | |
|---|---|---|---|---|---|
| 1^{st} | Solid | CGO ulsa | 70 vol.% | 5 vol. % solid | Milling 48 |
| depos. | phase | | | load | hours in |
| | | LSF | 30 vol. % | | ball mill |
| | Solvent | Ethanol | | | |
| | Surfactant | PVP K10 | | 5 wt. % of | |
| | | | | solid load | |
| | Binder | PVP K30 | | 5 wt. % of | |
| | | | | solid load | |
| 2^{nd} | | | | | Slow roll |
| depos. | | | | | min. 24 |
| | | | | | hours. |

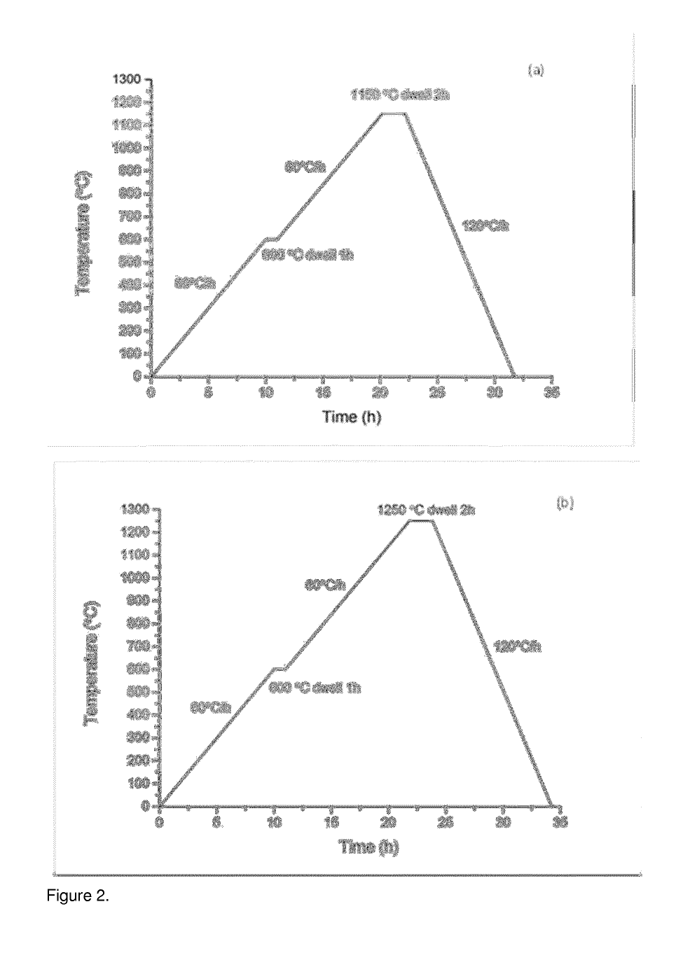

Deposition of the composite membrane is done on the green state tube (non-sintered tube) or pre-sintered inner porous CGO layer. For the present composite membrane the deposition of the CGO-LSF dense membrane layer was done on a pre-sintered tube (with the inner porous CGO layer deposited). The deposition of the dense layer is performed in two steps: Initial coating of CGO/LSF composite suspension, pre-sintering at 1150° C. with dwell time of 2 h (FIG. 2a) and deposition of a second coating of same dense suspension.

This double coating process with intermediate calcination/pre-sintering step ensures the elimination of organic contaminants and improves the chances of gas tightness of the dense membrane layer. As in case of the inner porous layer deposition, the solid loading of the suspension is adjusted to a solid loading of 5 vol.% to obtain a final sintered thickness of approx. 20 microns. The suspension should present ideal-viscous (Newtonian) behaviour with viscosity values within 3.5-4.0 mPa·s.

iv) Deposition of the Outer Porous CGO Layer

Deposition of the outer porous CGO layer is performed on the deposited CGO/LSF layer suspension (which was deposited on pre-sintered CGO/LSF layer). The same suspension composition as for the inner porous CGO layer deposition is employed (Table 2). As in previous layer depositions, the solid loading of the suspension was adjusted to 4 vol.% to obtain the final sintered thickness of approx. 15-25 microns. After the outer porous CGO layer deposition, the final sintering step at 1250° C. (dwell 2 h) is performed (FIG. 2b).

Higher or lower (1200° C. to 1300° C.) sintering temperatures can be used to achieve the gas tight CGO/LSF composite membrane layer. Nevertheless the balance between the porosity and the strength of porous structural MgO layer should be maintained.

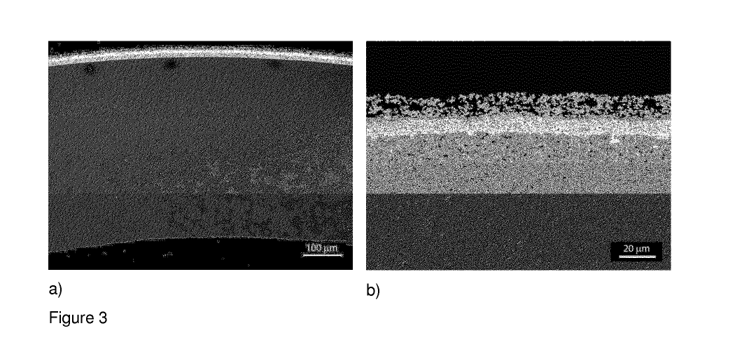

After sintering pre-test scanning electron microscopy images are shown in FIG. 3.

### Example 2

### Testing of Membranes

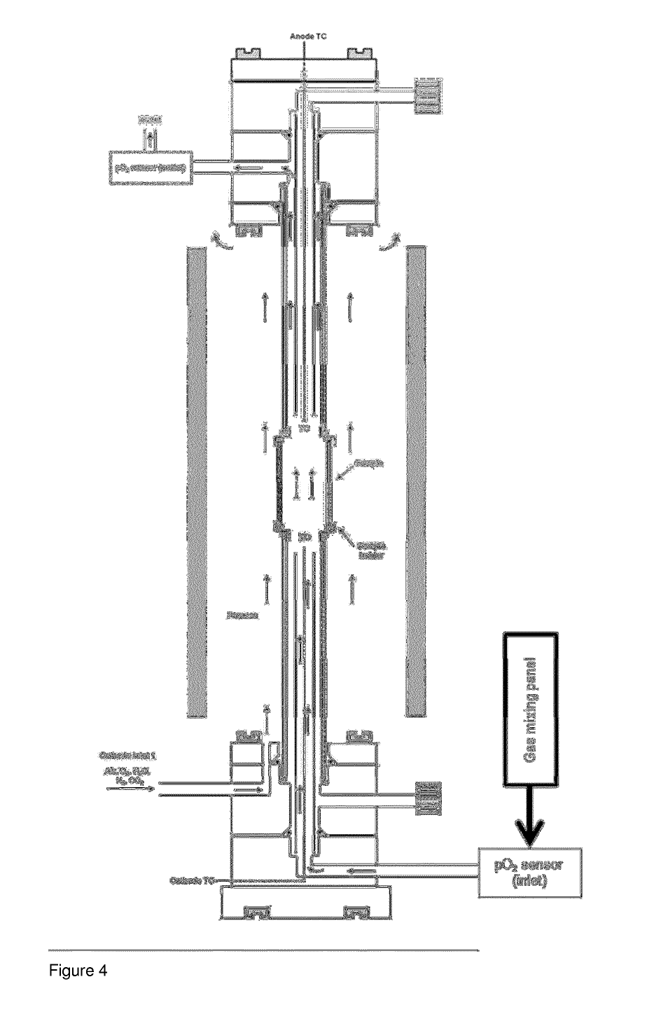

The test house for a tubular oxygen transport membrane is shown schematically in FIG. 4. The tubular membrane is connected to alumina tubes via specially designed alumina transition pieces. The transition pieces and the sample are mounted at room temperature using a glass ceramic paste consisting of Na₂O: 17.8 mol %, Al₂O₃: 9.4 mol %, and SiO₂: 72.8 mol % and an organic solvent. Upon heating to approximately 900° C. this glass ceramic paste can flow and seals the transition piece to both the membrane and the alumina tubes. The temperature near both ends of the tubular sample is monitored by two thermocouples that are located within each of the two connecting alumina tubes. Due to the length of the sample and the transition pieces, a temperature gradient of approximately 10° C. exists between the thermocouples at high temperature (900° C.). The alumina tubes connecting the tubular membrane sample is connected to the gas system of the rig. The lower alumina tube connects to the gas supply system where a variety of gasses can be prepared/supplied. When there is a difference in the chemical potential of oxygen between the two sides, oxide ions will be transported through the membrane, resulting in a net flux of oxygen through the membrane. The difference in chemical potential is typically realized by flowing air to one side of the membrane (the feed side) and a sweep gas such as nitrogen to the other side of the membrane (the permeate side).

The upper alumina tube, in which the sweep gas and permeate oxygen flows, is connected to an oxygen partial pressure sensor and a mass flow meter. On the feed side of the membrane (outer side of the membrane) 30 NL/h (NL=Normal liters) air was flowed at all times. On the permeate side of the membrane different flows of nitrogen where utilized in order to characterize the membrane performance as a function of the flow rate. The oxygen flux through the membrane is measured by measuring the inlet and outlet oxygen partial pressure of the used sweep gas with permeated oxygen, respectively. The flux can then be calculated from these numbers and the inlet flow of the sweep gas. It should be noted that the there is a slight overpressure inside the tube, wherefore it is known that the quantity of gaseous oxygen that is transferred to the permeate stream via leaks/pinholes in the membrane is very limited.

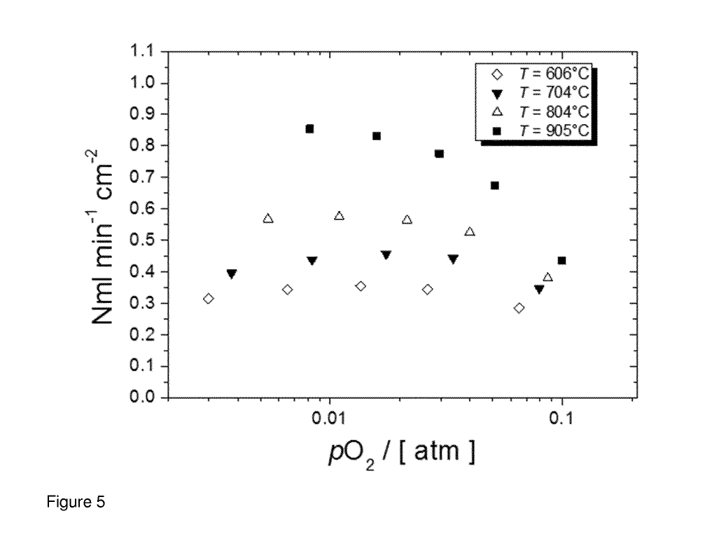

FIG. 5 shows the oxygen flux of the membrane as a function of the outlet oxygen partial pressure. It is clearly seen that with increasing temperature the flux also increases. In addition, the higher the driving force the higher the flux through the membrane. The results shown in FIG. 5 are for a membrane without infiltration. Membranes with infiltration will be tested in the very near future.

### Example 3

### Testing of Membranes with Only One Porous Layer Infiltrated

A membrane produced as in Example 1, but where only one of the porous layers was infiltrated, was tested. The porous layer which was not supported by the porous support was infiltrated with an ethanol based solution of lanthanum and cobalt nitrate. The nominal molar ratio of lanthanum and cobalt nitrate is such that it forms the composition LaCoO₃ upon heating.

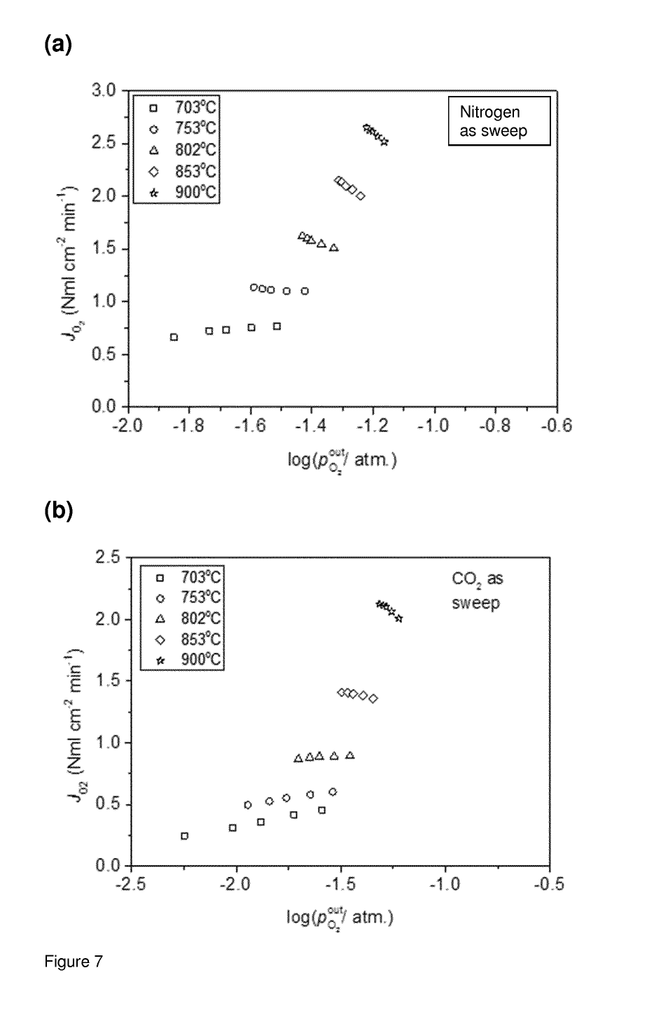

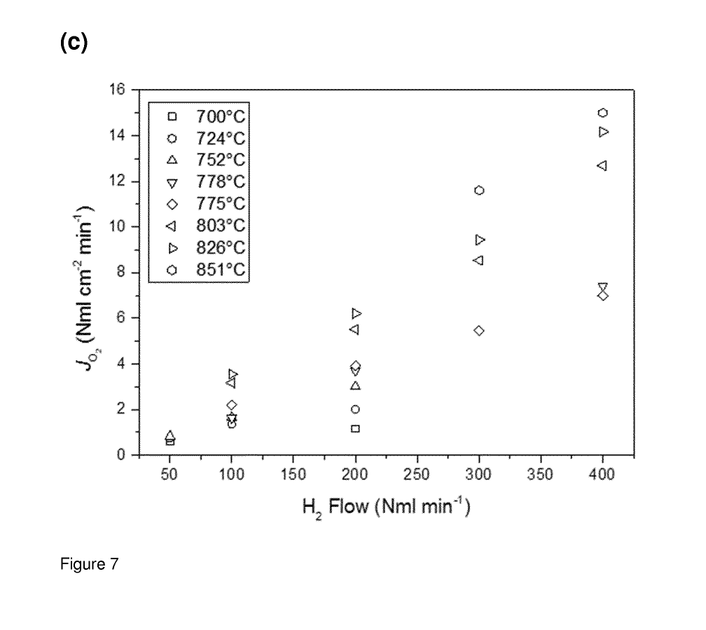

FIG. 7 shows the oxygen flux as a function of the outlet oxygen partial pressure, when (a) N₂ is used as sweep gas, and when (b) oxygen containing CO₂ is used as feed gas or sweep gas.

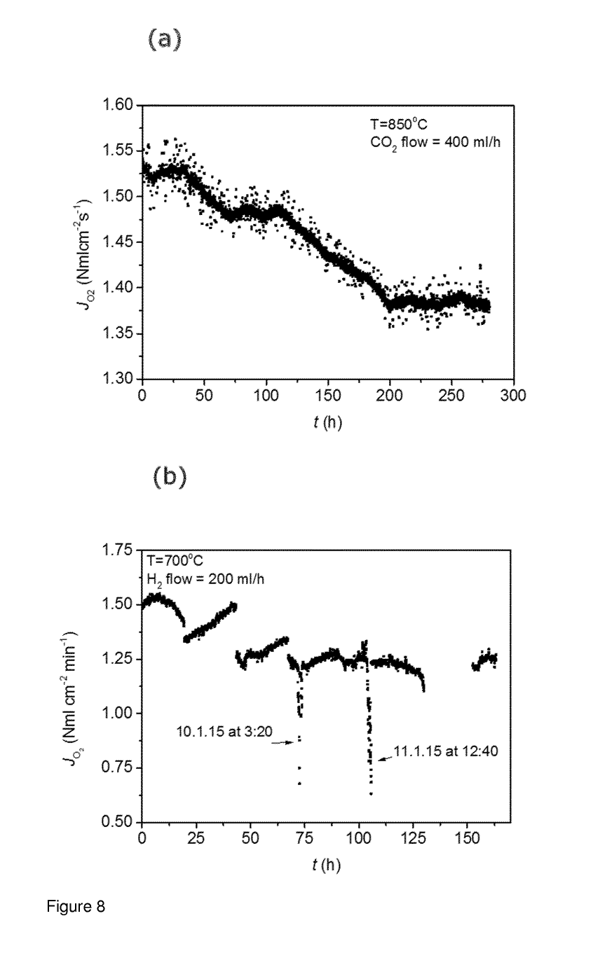

FIG. 8 shows the oxygen flux as a function of time (a) shows the flux at 850° C. in a CO₂ containing feed gas, and (b) shows the flux at 700° C. in a H₂ containing feed gas. At 850° C. a flux of approximately 2.2 and 1.45 Nml min⁻¹ cm⁻² are obtained when using nitrogen and CO₂ as sweep gas, respectively. This is considered a surprisingly high flux when the membrane is used in the present geometry, where the sweep gas is present on the support side of the membrane. It is also considered a very high flux as there has not been infiltrated a catalyst material into the porous layer on the support side to aid the oxygen evolution from the membrane. This means that the inner/first porous CGO combined with the interface of the membrane acts as surprisingly good catalytic layer. FIG. 7c shows the oxygen flux in hydrogen and at 851° C. a flux of approximately 16 Nml min-1 cm-2 is obtained. This is considered a surprisingly high oxygen flux for a thin film composite membrane on an inert support. It is further considered a surprisingly high oxygen flux as no catalyst material has been infiltrated into the first porous layer. The high fluxes are especially suprising, since the presence of catalyst on both sides of the membrane is known within the art to be essential for obtaining high fluxes. Furthermore, this is surprising since it is contrary to what is normally done in the related solid oxide fuel cell field, where one normally uses nickel as a catalyst to promote the catalytic properties.

1. A composite oxygen transport membrane comprising at least three layers, said layers being
a first porous layer,
a dense membrane layer positioned on top of the first porous layer, and
a second porous layer positioned on top of the dense membrane layer,
wherein the first and the second porous layer comprises a CGO (cerium gadolinium oxide), and
the dense membrane layer comprises at least one ionic conducting material and at least one electronic conducting material, where said at least one ionic conducting material is a CGO (cerium gadolinium oxide), and
wherein the first and/or the second porous layer is further supported by an inert porous support material, where the porous support material comprises magnesium (Mg).

2. The membrane according to claim 1, wherein the porous support material comprises MgO.

3. The membrane according to any of claims 1-2, wherein the porous support material is MgO.

4. The membrane according to any of claims 1 to 3, wherein the first porous layer and/or the second porous layer comprises at least 25 vol % CGO.

5. The membrane according to any of claims 1-4, wherein the first and/or second porous layer comprises above 95 vol % of a CGO.

6. The membrane according to any of claims 1-5, wherein the first and/or second porous layer comprises at least 99.9 vol % of a CGO.

7. The membrane according to any of claims 1 to 6, wherein the dense membrane layer consists of a CGO acting as both ionic conducting and electronic conducting material.

8. The membrane according to any of claims 1 to 6, wherein the electronic conducting material of the dense membrane layer comprises LSF (lathanum strontium ferrite).

9. The membrane according to any of claims 1-8, wherein the CGO of the first porous layer, the CGO of the dense membrane, and the CGO of the second porous layer, is a CGO of the same chemical formula.

10. The membrane according to any of claims 1-9, comprising one or more further ionic conducting material, such as (Pr,Tb,Sm,Nd)-doped CGO, (Pr,Gd)-doped CGO, (Pr,Gd)-doped ceria, and/or Sc-doped YSZ, and/or YSZ.

11. The membrane according to any of claims 1-6, 8-10, wherein the ionic conducting material is Ce_{0.9}Gd_{0.1}O_{1.95} and the electronic conducting material is (La_{0.6}Sr_{0.4})_{0.98}FeO₃.

12. The membrane according to any of claims 1-6, 8-11, wherein the volume ratio of the ionic and electronic conducting material is 50-90 vol % of Ce_{0.9}Gd_{0.1}O_{1.95} and 10-50 vol % of (La₁₋ₓSrₓ)_{y}FeO₃, more preferably 65-75 vol % of Ce_{0.9}Gd_{0.1}O_{1.95} and 25-35 vol % of (La₁₋ₓSrₓ)_{y}FeO₃.

13. The membrane according to any of claims 1-12, wherein the first and/or the second porous layer further comprises a catalyst.

14. The membrane according to claim 13, wherein the porous layer that is not supported by an inert porous support, comprises a catalyst, such as preferably LaCoO₃ and/or strontium-doped LaCoO₃.

15. The membrane according to claim 13-14, wherein the first and/or the second porous layer comprises strontium-doped LaCoO₃ as the catalyst.

16. The membrane according to claims 13-15, wherein the first porous layer comprises strontium-doped LaCoO₃ as the catalyst and the second porous layer comprises Ni or Ru or Cu, or any combination thereof, as the catalyst.

17. The membrane according to claims 13-16, wherein the size of the catalysts is below 500 nm, more preferably below 200 nm, and most preferably below 100 nm.

18. A process for preparing the membrane according to any of the proceeding claims said method comprising the steps of:
providing an inert porous support layer,
depositing a first porous layer on the porous support layer,
depositing a dense membrane layer on top of the first porous layer,
depositing a second porous layer on top of the dense membrane layer, and
infiltrating the second and optionally the first porous layer with a catalyst.

19. The process according to claim 18, wherein the inert porous support layer comprises Mg, more preferably comprises MgO, and most preferably is MgO.

20. Use of the composite oxygen transport membrane according to claims 1-17 in syngas production, oxygen production, oxygen enrichment of air, chemical production or oxygen production for biomass gasification, or oxygen production for glycerol decomposition.
